(19) United States
(12) Patent Application Publication
(10) Pub. No.: US 2025/0054388 A1
(43) Pub. Date: Feb. 13, 2025

(54) A HEATER INSERT FOR TRAFFIC SIGNALS

(71) Applicant: Michael M. Cubon, Park Ridge, IL (US)

(72) Inventor: Michael M. Cubon, Park Ridge, IL (US)

(21) Appl. No.: 18/722,130

(22) PCT Filed: Dec. 23, 2022
(86) PCT No.: PCT/US2022/053959

§ 371 Date: Jun. 20, 2024

Related U.S. Application Data
(60) Provisional application No. 63/295,332, filed on Dec. 30, 2021.

(51) Int. Cl. G08G 1/095; F21S 8/00; F21V 23/04; F21V 29/90; F21V 31/00; F21W 111/02; F21Y 115/10; H05B 1/02; H05B 3/34

(52) U.S. Cl. CPC G08G 1/095; F21V 23/0442; F21V 29/90; F21V 31/005; H05B 1/0202; H05B 3/34; F21S 8/00; F21W 2111/02; F21Y 2115/10; H05B 2203/02; H05B 2214/02

(57) ABSTRACT

A traffic signal having a light fixture comprising: a housing chamber; a door attached to the housing chamber, the door having an inner surface inside the housing chamber and an opposite outer surface on the outside of the housing chamber, the door having a window into the housing chamber, the window having a perimeter, an LED light assembly positioned inside the housing chamber, the LED light assembly having a lens positioned through the window, the lens being visible outside the housing chamber; a visor extending from the outer surface of the door, the visor being attached to the door and fitted around at least a portion of the window perimeter; and a heater insert extending from the outer surface of door, the heater insert surrounding at least a portion of the window perimeter, the heater insert comprising a heater attached to a carrier.

### CROSS-REFERENCE TO RELATED PATENT APPLICATIONS

This application claims the benefit of priority from U.S. Provisional Patent Application 63/295,332 filed Dec. 30, 2021, the entire disclosure of which is herein incorporated by reference.

### TECHNICAL FIELD

This disclosure relates to LED traffic signals comprising heater inserts which contain positive temperature coefficient heating (PTC) elements, and methods for improving visibility of snow-covered LED traffic signals.

### BACKGROUND

Light Emitting Diodes (LED) provide significant operational cost savings and are commonly used in traffic control systems. In contrast to previously used incandescent bulbs, LED lights generate very little or no heat, leading to accumulation of snow and/or ice on the surface of a traffic signal under cold weather conditions. Many LED traffic signals include a visor surrounding and protecting an LED light, as shown for example in FIG. 1. A visor may facilitate significant accumulation of snow and ice on the surface of the traffic light. If snow and/or ice covers the surface of an LED traffic light, the LED light does not generate enough heat to melt it. This may result in the LED traffic lights no longer be clearly visible to motorists and pedestrians, leading to an onset of hazardous conditions on a road until snow/ice is melted or removed.

Certain factors may contribute to collection of snow in an LED traffic signal having a visor. Without heat, the visor allows for snow to be captured in the LED area in front of lens in amounts that may be large enough to impact the light output. When a temperature is slightly warmer than 0° C., snowflakes may melt around the edges of the visor and compound on a surface of the LED lens. Wind may also contribute to the problem by forcing snow onto the surface of the visor and lens.

Various attempts have been made to prevent accumulation of snow and ice on LED traffic lights. For example, U.S. Pat. No. 10,223,913 proposes to use a cone shaped lens placed over the LED light. This technical solution relies on wind to blow the snow around the lens. However, any snow that builds up on the cone may still cover and obstruct the LED light.

US patent publication 2021/0174676A1 discloses a heater attached to the visor, but there is a concern that the visor can act as a heat sink, diverting some heat away from the lens area to which the heat should be transferred in order to melt snow which covers lens.

Another proposed solution involves a heater wire embedded into the LED surface lens. This approach requires an expensive manufacturing process and can have impact on the light output. Non-traffic LED heaters, such as those described in US patent publication 2020/0290502A1 require a LED light lens having a heater wrapped around the perimeter of the lens and are ineffective at melting snow not touching the lens directly. The present invention solves the issue with a more efficient, easier to assemble, and better performing design.

Thus, there remains the need in the field for improved LED traffic lights that can protect lens from being covered with snow and/or ice.

### SUMMARY

This disclosure provides a technical solution for keeping LED traffic lights substantially clear from snow and ice accumulation.

In one aspect, the disclosure relates to a heater insert that can be assembled with an LED traffic light such that a heater of the heater insert is placed in front of an LED traffic light lens, preventing accumulation of snow and improving visibility of a snow-covered traffic signal. The heater insert comprises a positive temperature coefficient (PTC) heater attached to a carrier configured for mounting to a traffic signal door and/or to an LED assembly. In some preferred embodiments, the heater insert may further comprise an energy-saving moisture sensor which switches the heater insert on only when snow moisture is detected.

A traffic signal having a light fixture may comprise: a housing chamber; a door attached to the housing chamber, the door having an inner surface inside the housing chamber and an opposite outer surface on the outside of the housing chamber, the door having a window into the housing chamber, the window having a perimeter, an LED light assembly positioned inside the housing chamber, the LED light assembly having a lens positioned through the window, the LED lens being visible outside the housing chamber; a visor extending from the outer surface of the door, the visor being attached to the door and fitted around at least a portion of the window perimeter; and a heater insert extending from the outer surface of door, the heater insert fitted through the opening in the housing door from the inside of the chamber, the heater insert surrounding at least a portion of the window perimeter, the heater insert comprising a carrier having an inner surface and an outer surface and a heater, the heater being attached to the either surface of the carrier.

Some embodiments of the traffic signal include those, wherein the carrier is made of a metal or plastic.

In some embodiments, the heater insert may have positive temperature coefficient (PTC) characteristics and/or fixed wattage characteristics. In some embodiments, the heater insert may have the heater screen printed directly onto the carrier. In some embodiments, the heater insert may be mounted to the housing door with an adhesive and/or a mechanical fastener.

The traffic light signal of claim 1, wherein the heater insert is held in position by the LED light assembly.

In some embodiments, the traffic light signal may further comprise a control module connected to the heater insert for sensing moisture and one or more moisture sensors positioned on the heater insert.

In some embodiments, the traffic light signal may further comprise a control module connected to the heater insert for controlling the on/off function of the heater insert.

In some embodiments, the traffic light signal may further comprise a control module used to limit the current into the heater insert.

In yet another aspect, the disclosure provides a traffic signal heater insert comprising: a carrier having a surface, and a heater positioned on the surface of the carrier. In some embodiments, the heater may be screen-printed directly on the carrier.

In yet another aspect, this disclosure provides a light fixture comprising: an LED light assembly; a sealing gasket provided on the LED light assembly; and a heater insert attached to the LED assembly with the sealing gasket. The light fixture embodiments include those, wherein at least a portion of the heater insert is in front of the LED light assembly.

In yet another aspect, this disclosure provides a light fixture comprising: LED light assembly; a flange around the LED light assembly; and a heater insert attached to the LED assembly to the flange. In some embodiments, at least a portion of the heater insert may be in front of the LED light assembly.

In yet another aspect, this disclosure provides a traffic signal heater insert comprising: a carrier having a surface, and a heater positioned on the surface of the carrier and moisture sensing circuit integrated into the heater. In some embodiments, the moisture sensing circuit may use conductivity to detect moisture. In some embodiments, the moisture sensing circuit may use capacitance to detect moisture. In some embodiments, the moisture sensing circuit may use resistance to detect moisture.

In another aspect, the present disclosure relates to a traffic signal assembled with one or more heater inserts according to this disclosure.

In yet further aspect, this disclosure relates to methods for improving visibility of a traffic signal, the methods comprising mounting one or more heater inserts according to this disclosure to the traffic signal.

### BRIEF DESCRIPTION OF THE DRAWINGS

FIG. 1 depicts one embodiment of a traffic signal having a light fixture.

FIG. 2 depicts one embodiment of a heater insert according to this disclosure.

FIG. 3A is a perspective view of one embodiment of a heater and a carrier according to this disclosure, unassembled.

FIG. 3B is a side view of a heater insert in which the heater of FIG. 3A is positioned into the carrier of FIG. 3A.

FIG. 3C is another side view of the heater insert assembled from the heater and the carrier of FIG. 3A.

FIG. 4A depicts mounting the heater insert into an LED recess of a traffic signal door window.

FIG. 4B depicts the heater insert fully seated into the LED recess.

FIG. 4C depicts assembling an LED light to the door window.

FIG. 4D depicts the front view of a traffic signal after the heater insert and LED light are assembled with the door.

FIG. 5A depicts one embodiment of the heater insert mounted to a traffic light.

FIG. 5B depicts attaching a visor to the assembly of FIG. 5A.

FIG. 6A-6D depict an alternative embodiment for mounting the heater insert to a traffic light. FIG. 6A depicts an LED light assembly. FIG. 6B depicts the LED light assembly of FIG. 6A assembled with the heater insert and an unassembled sealing gasket. FIG. 6C depicts the sealing gasket secures to the LED light assembly. FIG. 6D depicts the heater insert secured to the LES light assembly with the sealing gasket.

FIG. 7A depicts an alternative embodiment for mounting the heater insert to a traffic light with the heater insert flanges/tabs.

FIG. 7B is a cross-section of the assembly of FIG. 7A along the A-A axis.

FIG. 8A depicts a traffic light assembled with the heater insert and a visor being assembled to the traffic light door.

FIG. 8B depicts the assembled traffic light with the visor being attached to the traffic light door.

FIG. 9 depicts an embodiment of a heater according to this disclosure which includes one or more moisture sensors.

FIG. 10A depicts one embodiment of the heater according to this disclosure, comprising conductive busses connected with a PTC layer.

FIG. 10B depicts conductive busses of FIG. 10A without the PTC layer.

FIG. 10C depicts the PCT layer of FIG. 10A without the conductive busses.

### DETAILED DESCRIPTION

In one aspect, this disclosure provides a heater insert configured for installation on traffic signals, including road traffic signals, railroad crossings, pre-emption receiver sensors, and pedestrian signals. The traffic signal heater insert may reduce or prevent accumulation of snow and/or ice on an LED traffic signal lens, thereby improving visibility of traffic signals during inclement weather.

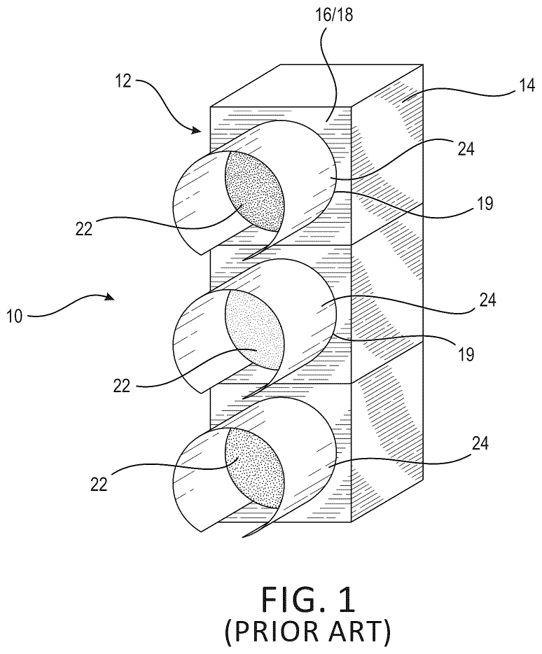

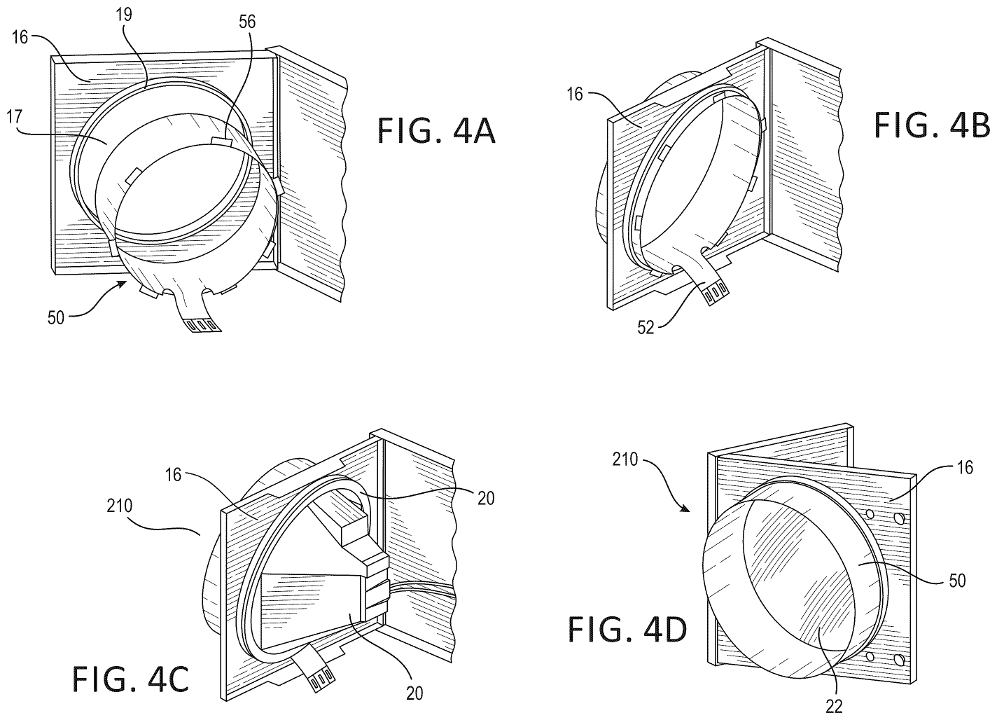

The traffic signal heater insert according to this disclosure may be used with any traffic signal known in the art. Referring to FIG. 1, a traffic signal known in the art, generally (10), may include a light fixture (12) comprising a housing chamber (14) with a housing door (16) attached to the front surface (18) of the housing chamber (14). The housing door (16) may be opened and when it is open, it provides access into the housing chamber (14) which serves as a chamber for housing one or more LED light assemblies (20) positioned in the housing chamber (14) as can be seen for example in FIG. 4C, showing a fragment of the housing chamber (14) with the housing door (16) being open and the LED light assembly (20) being positioned in the housing chamber (14).

The housing door (16) may have one or more windows (17). The window (17) may be simply an opening in the housing door (16), or the window (17) may be covered with a transparent material such as for example as glass or plastic.

The LED light assembly (20) is arranged behind the housing door (16) in the housing chamber (14) with a lens (22) of the LED light assembly (20) aligned with the window (17) of the housing door (16) such that when the LED light assembly (20) emits light through the lens (22), the light is visible on the front surface (18) of the housing chamber (14). Typically, the lens (22) is sealed or otherwise attached to the window (17) edge for example with a sealing gasket and/or by some other means in order to prevent penetration of rain and snow into the housing chamber (14) through the window (17).

In order to shield the lens (22) from sunlight, the traffic signal (12) may include a visor (24) connected with its one edge to the surface of the housing door (16). The visor (24) extends substantially perpendicular to the front surface (18) of the housing chamber (14) and protects the lens (22). In some embodiments, the visor (24) is aligned with the window (17) and is attached to the edge (19) or near the edge (19) of the window (17), and/or to any other portion on the housing door (16).

In some preferred embodiments, the window (17) may be substantially round, and its edge (19) is substantially circular. Any other configuration/shape for the window (17), including square or oval, are also suitable and are commonly used in traffic signals. The visor (24) may be attached to the housing door (16) around at least a portion of the window edge (19). Thus, a perimeter of the visor (24) may be configured with a perimeter of the window (17) such that the visor (24) extends over an upper portion of the window (17) when the traffic signal (12) is installed on a street and in use. If the housing door (16) has more than one windows (17), each of the windows (17) or at least some of the windows (17) may be protected with the visor (24).

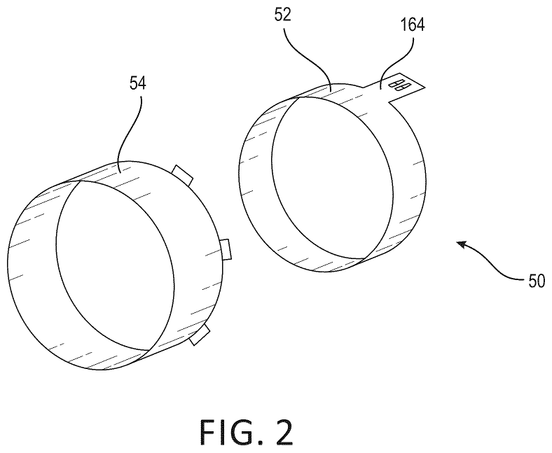

Referring to FIGS. 2, 3A, 3B and 3C, and 10A, 10B and 10C in one aspect, this disclosure provides a heater insert, generally (50), preferably configured for being mounted to the window (17) of the LED light assembly (20) such that at least a portion of the heater insert (50) is positioned in front of the LED lens (22). The heater insert (50) may comprise at least a heater (52) and a carrier (54).

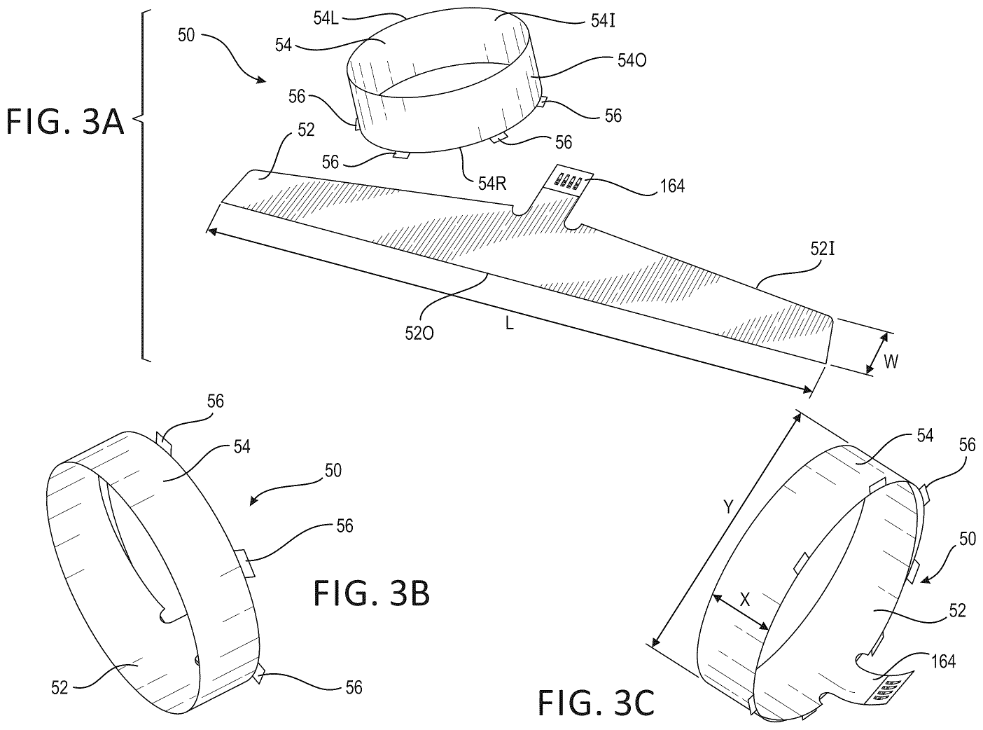

The heater (52) is preferably a thin and flexible material comprising conductive elements and which may be shaped as a stripe having a length (L) and a width (W). In some embodiments, the heater (52) may be from about 0.003″ to about 0.015″ thick. Preferably, the length (L) is larger than the width (W). The heater (52) has two long edges: a first long edge (52O) that will be located outside the housing chamber (14) and in front of the lens (22) when the heater insert (50) is assembled with a traffic light and a second long edge (52I) opposite to the first long edge (52O). The second long edge (52I) may be located inside the housing chamber (14) when the heater insert (50) is assembled with a traffic light. For example, the second long edge (52I) may be located in the window recess (19). The length (L) and the width (W) of the heater (52) are configured such that the heater (52) can be attached to a surface of the carrier (54), one embodiment of which discussed in more detail below in connection with FIGS. 3B and 3C.

The heater (52) includes a terminal (164) for connecting the heater (52) to a voltage source (not shown). Preferably, the terminal (164) is positioned at the edge (52I) of the heater (52). In some embodiments, the edge (52I) may be tapered at least partially on each side from the central line of the edge (52I) to its end points.

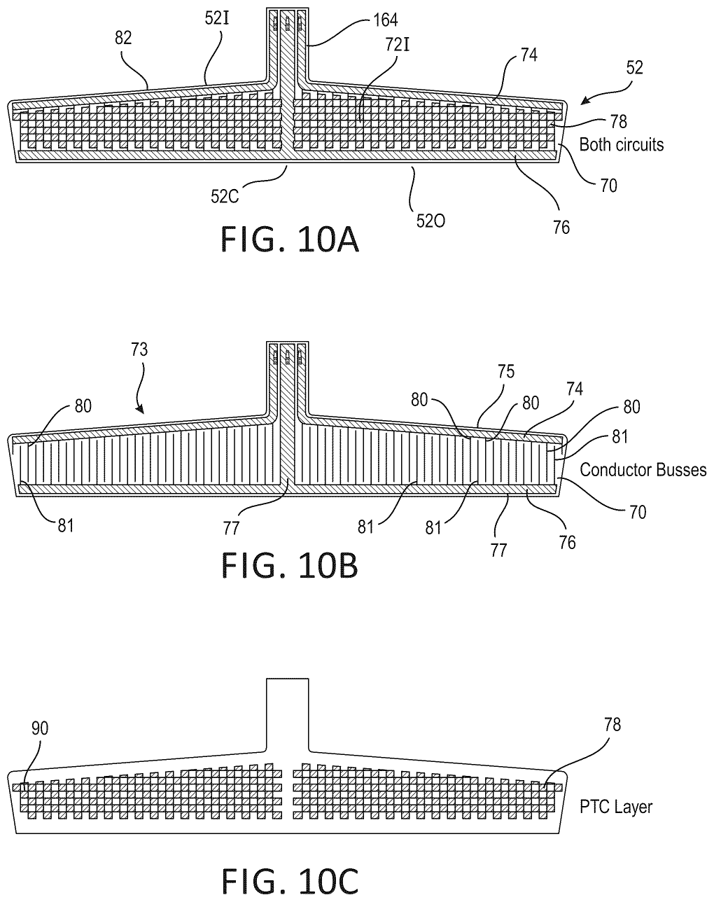

The heater (52) may be a positive temperature coefficient (PTC) self-regulating heater or a fix-wattage heater. Preferably, the heater (52) is a PTC self-regulating heater which comprises PTC heating elements that have a positive change in resistance as the temperature of the heater increases, one embodiment of which is shown in FIGS. 10A, 10B and 10C.

When a voltage is applied from a voltage source (not shown) to the heater (52) through a terminal (164) attached to the heater (52), the heater (52) produces heat.

In this disclosure, a PTC self-regulating heater (52) may include a material composed of conductive particles dispersed in a resin system. The heater (52) has an electric resistance value. The electric resistance value of the heater (52) may change in response to changes in a temperature of the environment in which the heater (52) is placed. If the environment temperature increases, the electric resistance of the PTC heater (52) increases, which reduces the current flow through the heater (52). Accordingly, the PTC heater (52) generates more heat at a lower temperature and draws less power at a higher temperature.

Referring to FIGS. 10A, 10B and 10C, the heater (52) in this disclosure can be also referred to interchangeably as a heating element or a heating component. A suitable heating element (52) for the heater insert (50) may be flexible and may comprise a polymer film carrier layer (70) and a circuit (72) deposited on the polymer film carrier layer (70) as shown in FIG. 10A. The circuit (72) can be a Positive Temperature Coefficient (PTC) element comprising a conductive layer (73) which may include at least two electrically conductive busses spaced from each other, a first electrically conductive bus (74) and a second electrically conductive bus (76), the first electrically conductive buss (74) and the second electrically conductive buss (76) being connected by a resistive layer (78), also referred to as the PTC heater layer or the PTC layer.

As can be seen in more detail at FIG. 10B, the conductive busses (74 and 76) may be composed of a flexible polymeric ink comprising conductive particles, for example silver, the conductive particles having a lower resistance than the resistive layer (78).

A first conductive bus (74) may comprise a base (75) which is preferably located at one of the long edges (52O or 52I) of the heater (52). The base (75) is connected to a plurality of fingers (80) extending from the base (75) over the surface of the heater (52). Preferably, the first conductive base (75) is located along at least a portion of the inside edge (52I) and also along one or both edges of the terminal (164) of the heater (52).

A second conductive bus (76) may comprise a base (77) spaced from the first base (75). In some embodiments, the base (77) may be located at the long edge which is opposite to the long edge at which base (75) is located. Preferably, the second conductive base (77) is located along at least a portion of the outside edge (52O) and also substantially along the central line (52C) of the heater (52) and through the central line of the terminal (164).

The base (75) is connected to a plurality of fingers (81) extending from the base (75) over the surface of the heater (52). The width of each of the two bases (80 and 81) may be same or substantially the same, or it may be different. In preferred embodiments, the width of the bases is significantly longer than the width of fingers (80 and 81). The fingers (80) and the fingers (81) are spaced from each other.

A pattern, a number, a length and widths of the bases (74 and 76) and fingers (80 and 81) may be adjusted as needed in order to decrease or increase the watt density of the heater (52).

Referring to FIG. 10C, the resistive layer (78) may comprise a carbon loaded polymer and this layer produces the PTC effect at a predetermined temperature. Referring to FIG. 10A, the resistive layer (78) electrically connects the busses (74 and 76). The resistive layer (78) has a higher electrical resistance than the conductive layer comprising the busses (74 and 76). The resistive layer (78) may be composed of a plurality of resistive elements (90), each element (90) being preferably shaped as a stripe and each stripe (90) contacting with and engaging at least one finger (80) on the bus (74) with at least one finger (81) on the bus (76). The resistive layer (78) has a higher electrical resistance than the conductive layer comprising the busses (74 and 76).

When connected to a power source through the terminal (164) and power is applied, the heater (52) produces heat. The resistive layer (78) has a higher electrical resistance than the conductive layer comprising the busses (74 and 76). The resistive layer (78) generates heat when a voltage applied to the busses (74 and 76) through the terminal (164).

One method for applying the conductive (73) and resistive layers (78) to the film (70) is through screen printing After the circuit is deposited onto the film surface (70), a terminal (164) can be attached to the heater (52). An adhesive layer (82) may be then applied over the heater (52) and seals the circuit. This adhesive layer (82) can be double-sided and may be further used to mount the heater (52) to the insert carrier (54). A wire harness (not shown) can be connected to the terminal (164) for connection to a voltage source (not shown).

Preferably, the carrier (54) is a stripe which has a length (Y) and width (X), having an inner surface (54I) and an outer surface (540). The carrier (54) can be made of a metal, such as for example as aluminum, or a variety of plastics. The carrier (54) can be made into a circular shape, or any other desirable shape configured to a shape and size of the window (17). The length (Y) or a diameter of the carrier (54) is such that when the carrier (54) is in circular shape it can surround the LED lens (22). The width (X) of the carrier (54) can vary, but preferably the width (X) of the carrier (54) is smaller than a width of the visor (24). The carrier (54) may further have one or more flange tabs (56) along one edge of the carrier (54) for attachment of the carrier (54) to the edge of the window (17). Other means, e.g., a sealing gasket and/or an adhesive and/or a rim and/or mechanical fasteners, for attaching the carrier (54) in addition to, or instead of, the flange tabs (56) to a traffic signal can be also used.

The heater (52) has a length (L) and width (W), wherein the width (W) of the heater (52) is smaller than the width (X) of the carrier (54) and the length (L) of the heater (52) is smaller than the length (diameter) (Y) of the carrier (54). The heater (52) may be assembled to the inner surface (54I) and/or to the outer surface (540) of the carrier (54) by overlaying the inner surface (54I) with the heater (52) and then adhering the heater (52) to the inner surface (54I and/or outer surface 540), preferably with an adhesive, tape, or over-molded, or mechanically attached. In some embodiments, the heater (52) is positioned on the inner surface (54I) such that at least a portion of the inner surface (54I) near its edge (periphery) 54L and/or near its edge (periphery) 54R remains not covered by the heater (52).

Other methods for assembling the heater (52) to the carrier (54) may include over-molding and/or mechanical fasteners. In some embodiments the heater insert (50) may be manufactured as a single piece. In these single-piece embodiments, the heater (52) may be printed directly on the surface (54I and/or 540) of the carrier (54) while the carrier (54) is in the flat state and the heater insert (50) is then formed into a circular shape or into any other shape suitable for positioning withing the window (17).

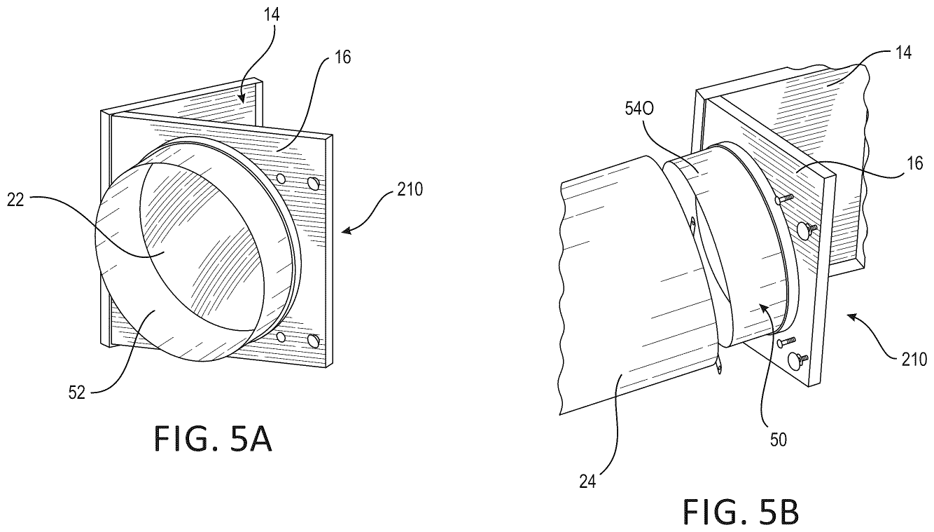

Referring to FIGS. 4A-4D, 5A and 5B, a fragmentary view of one embodiment of a light fixture wherein the light fixture is a traffic signal comprising the heater insert (50) according to this disclosure, generally (210), is shown. When attached to the window (17) inside the housing (14), the heater insert (50) extends outside the window (17) as shown in FIG. 4D. The heater insert (50) can be held in place by the LED light assembly (20) and/or an adhesive, or other mechanical fasteners and/or flange tabs (56).

Thus, when assembled with a traffic light (12), the heater insert (50) may be positioned in front of one or more the LED lens (22) and provides heat in front of the LED lens (22), preventing a snow and/or ice buildup and also melting snow and/or ice that has accumulated on the LED lens (22). This technical improvement to a traffic signal improves visibility of a snow-covered traffic signal.

In one preferred embodiment, the heater insert (50) is shaped into a shape which is configured to a shape of the LED light lens (22), preferably circular if the LED light lens (22) is of a circular shape. The heater insert (50) extends past the front surface of the LED lens (22), heating the area in front of the lens (22). It is preferred that the heater (52) does not come in direct contact with the LED lens (22) or the visor (24) in order to minimize a loss of heat through the visor (24) or the lens (22). The width (W) of the heater (52) is smaller than the width (X) of the carrier (54). Preferably, the heater (52) overlays the inner surface (54I) of the carrier (54) such that a portion of the inner surface (54I) near at least one edge or both (54R and/or 54L) of the carrier (54) is not covered with the heater (52). Accordingly, the lens (22) and/or the visor (24) do not necessarily come into a direct contact with the heater (52) as the heater (52) may be separated from the lens (22) and/or the visor (24) by the carrier (54).

In yet another embodiment, this disclosure relates to a method for attaching the heater insert (50) to a traffic light housing (12). As shown in FIG. 4A, the door (16) is open into the housing chamber (14). The heater insert (50) is mounted to a LED recess (19) of the window (17) from the inner surface of the door (16) and through the window (17). The shape and diameter (perimeter) of the heater insert (50) is configured to fit snugly into a shape and a diameter (perimeter) of the window (17) such that the heater insert (50) inserted from the inner surface of the window (17) and through the window (17) is seated into the LED recess and secured with tabs (56) resting on the window recess with a portion of the heater insert (50) extending in front of the outer surface of the door (16) as shown in FIG. 4C. In other embodiments, a flange or one or more clips can be used in addition to or instead of the tabs (56).

As shown in FIG. 4C, the LED light (20) is then assembled to the door (16) from the inner surface of the door (16) and being positioned through the window (16). The LED light (20) clamps the heater insert (50) in place on the door (16).

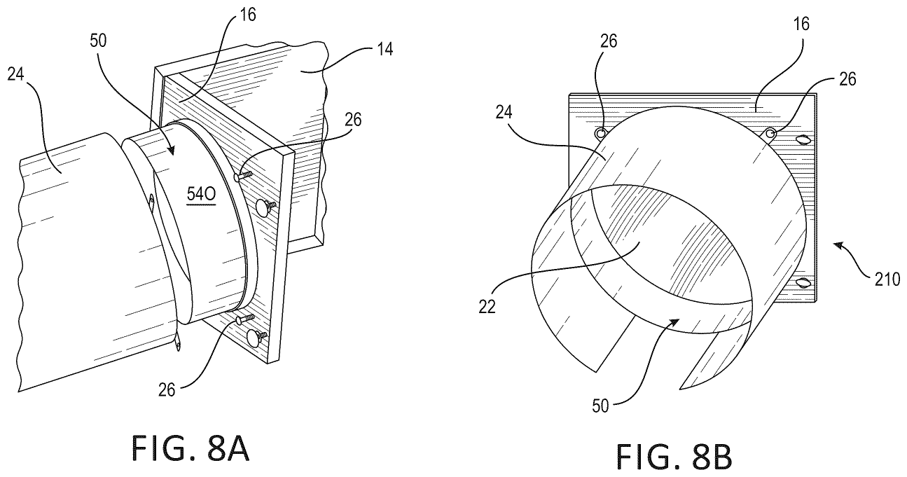

FIG. 4D and FIG. 5A show the front view of the traffic signal (210), after the heater insert (50) is assembled. A portion of the heater insert (50) extends from the front surface of the door (16) and surrounds at least a portion of the lens (22) perimeter. As shown in FIGS. 5B, 8A and 8B, the visor (24) is then assembled with the traffic signal (210) by fitting over the outer surface (540) of the heater insert (50). The visor (24) is then secured on the front surface of the door (16) for example, with one or more screws (26). The shape and perimeter of the heater insert (50) is configured such that the visor (24) fits over the heater insert (50). The assembled traffic light (210) has several technical advantages, including: it provides a required heater to prevent and/or remove snow and/or ice. The heater insert (50) surrounds the LED lens (22), allowing heat to rise over the front of the LED lens (22). The heater insert (50) does not interfere with the light output from the LED light.

While heat dissipation is a common drawback in prior art heaters, the present heater insert (50) overcomes this disadvantage by minimizing the heat loss through the visor (24). It is preferred that the heater insert not contact the visor to minimize heat dissipating through the visor. This allows for the heat to rise over the LED lens (22) surface without impacting the light output and in addition to heating the area in front of the LED light lens (22).

Additionally, the heat insert (50) allows for heat to be in the area near the lower base of LED light, allowing heat to rise over the LED lens (22) without the heater (52) coming in contact with the LED lens (22). It is preferred that the heater insert (50) be of the same color as the visor (24) in some embodiments. In other embodiments, the heater insert (50) may be made in a color contrasting with the visor (24) such that it is easy for a technician to determine whether a traffic light has been fitted with the heater insert (50).

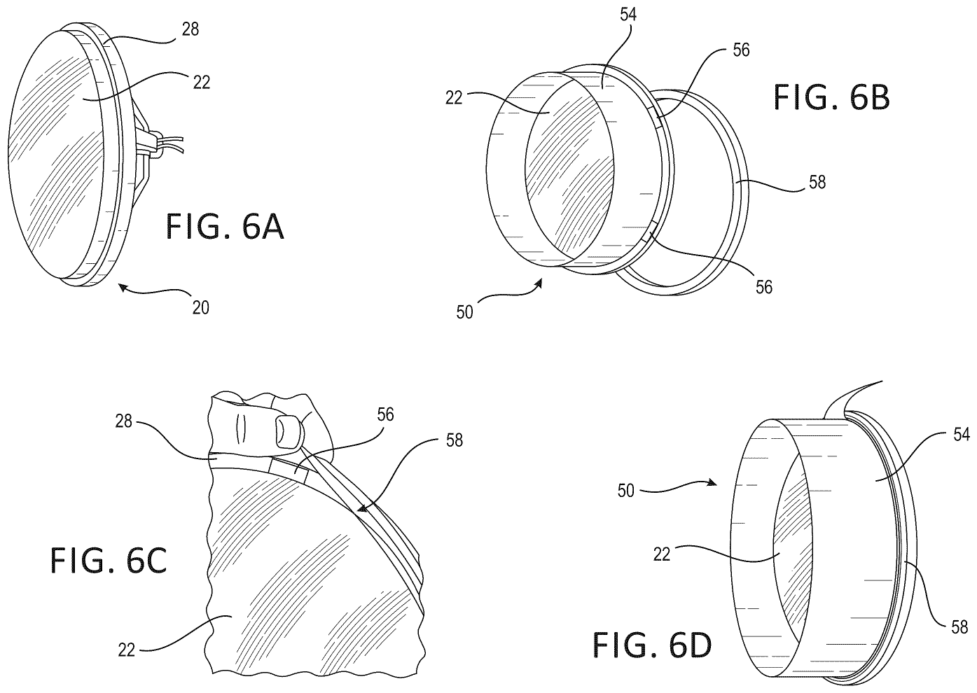

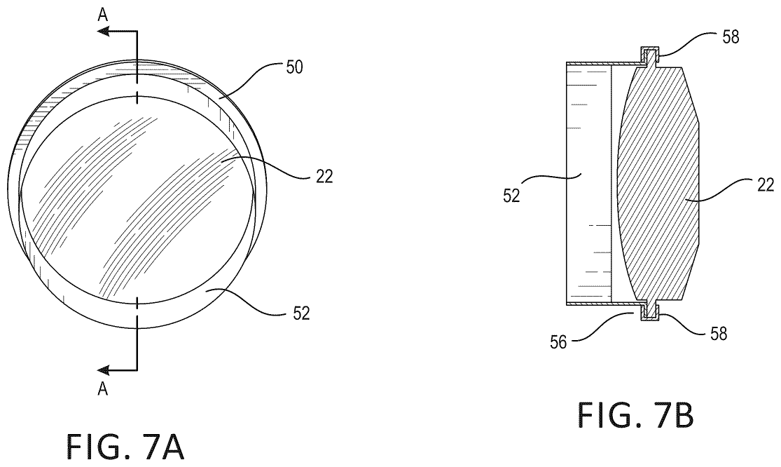

Referring to FIGS. 6A, 6B, 6C, 6D, 7A and 7B, this disclosure provides an alternative embodiment for mounting the heater insert (50) to a traffic signal (10). In this embodiment, flanges/tabs (56) of the carrier (54) are placed on the LED flange (28) of the LED light assembly (20) as shown in FIG. 6B and a sealing gasket (58) then secures the heater insert (50) to the LED light assembly (20), for example as shown in FIGS. 6C and 7A and 7B.

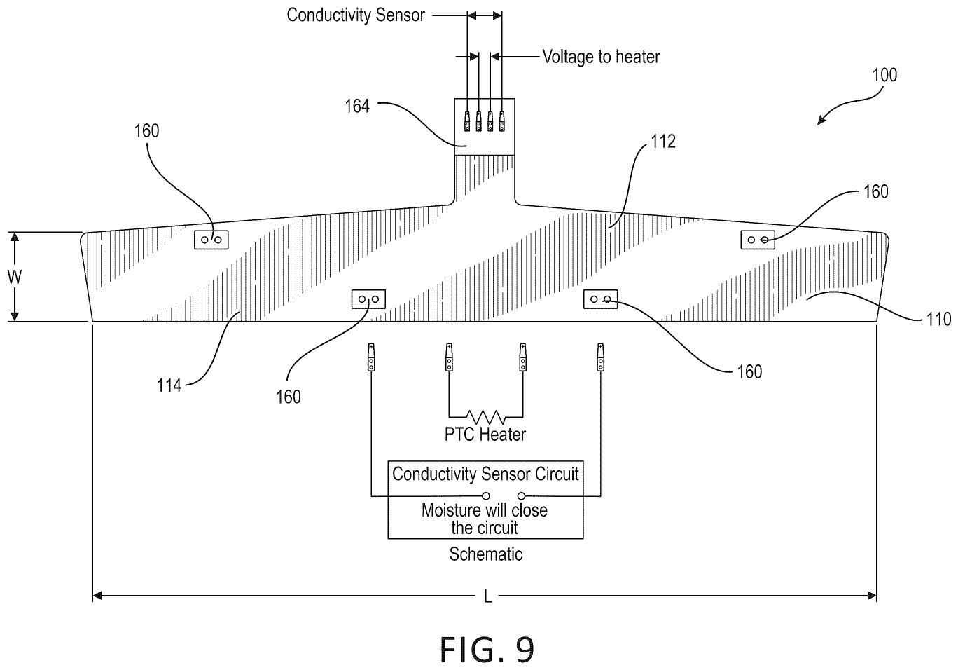

Referring to FIG. 9, in yet further embodiment, the heater insert (100) according to this disclosure may comprise one or more moisture sensors (160). Energy efficiency requirements dictate that there be some level of power on/off control for heat. Therefore, the environmental condition necessary for snow buildup can be monitored with sensors (160), through a control module. A control module can receive information from sensors for temperature, humidity, wind, conductivity, capacitance, and/or moisture in snow. A moisture buildup in the LED light area is an indicator that snow may be present. Sticky snow is caused when the snow has increased moisture content. As moisture rises in snow (at temperatures closer to freezing), snow crystals break down and the moisture in between the snow will hover below freezing. This allows the humidity in the snow to migrate and condense on a particle of snow or ice, and then freeze to bond one particle to another.

A moisture buildup is an indicator that snow may be present. The moisture ratio of the snow plays a part in whether the snow will stick to the visor (24) and lens (22). Typically, moisture in the snow can be represented as a ratio. For example, a 10:1 ratio, means for every ten inches of snow, there is a one-inch liquid equivalent. Light snow will have a bigger ratio, around P20:1, while heavier, sticky snow, may have the ratio 5:1.

In further embodiments, this sensor module (160) may use wireless technology to connect to various weather reporting sights for a heater power on when conditions are met. Additionally, a manual override feature may be included that allows for the heater power to be turned on by an operator. Because of the variable resistance of a PTC heater, the heater resistance can be used to determine when to turn on the heater insert (100).

The control module can also be configured to vary the voltage to the heaters allowing for a more efficient operation. For example, a Pulse Width Modulation (PWM) signal can be used to run a voltage duty cycle to the heaters allowing for an adjustable voltage input to the heaters.

Energy savings is a large part of the benefit of using LEDs. It is important that the heater insert (50) be as efficient as possible. The most efficient way to operate the heater insert is to turn on the heater element (78) only when show is present. One method for ensuring the efficiency is to turn on the heater inserts when moisture is present, and the temperature is at or below the freezing point. Moisture can be detected through a conductivity circuit, resistivity circuit, capacitance circuit or a combination of these circuits. One aspect of the invention is to include a moisture sensing circuit directly on the heater insert to allow the moisture in the snow to close the circuit and send a conductivity signal to the module to turn on the heater element (78) as shown in FIG. 9 showing a simple schematic and a sensor (160) layout.

The heater insert (50 or 100) according to this disclosure provides at least the following technical benefits:
1) Eliminates snow buildup on LED traffic signals;
2) Has a moisture sensor for efficient, cost-effective, heater operation;
3) PTC heaters are self-regulating;
4) Standard design allows for use across multiple manufacturers of traffic signals;
5) Heater design can be configured to new design of traffic signals;
6) The heater does not change the light output of the LED light;
7) The heater is a standalone component and easier to install then other devices;
8) Easier retrofit installation at point of use;
9) The heater does not require any modifications to the existing visor, light, or traffic signal housing; and
10) The heater insert can be removed or replaced without impacting any other component in the traffic signal assembly.

I claim:

1. A traffic signal having a light fixture comprising:
a housing chamber;
a door attached to the housing chamber, the door having an inner surface inside the housing chamber and an opposite outer surface on the outside of the housing chamber,
the door having a window into the housing chamber, the window having a perimeter,
an LED light assembly positioned inside the housing chamber, the LED light assembly having a lens positioned through the window, the LED lens being visible outside the housing chamber;
a visor extending from the outer surface of the door, the visor being attached to the door and fitted around at least a portion of the window perimeter; and
a heater insert extending from the outer surface of door, the heater insert fitted through the opening in the housing door from the inside of the chamber, the heater insert surrounding at least a portion of the window perimeter, the heater insert comprising a carrier having an inner surface and an outer surface and a heater, the heater being attached to the either surface of the carrier.

2. The traffic signal of claim 1, wherein the carrier is made of a metal or plastic.

3. The traffic signal of claim 1, wherein the heater insert has positive temperature coefficient (PTC) characteristics and/or fixed wattage characteristics.

4. The traffic signal of claim 1, wherein the heater insert has the heater screen printed directly onto the carrier.

5. The traffic light signal of claim 1, wherein the heater insert is mounted to the housing door with an adhesive and/or a mechanical fastener.

6. The traffic light signal of claim 1, wherein the heater insert is held in position by the LED light assembly.

7. The traffic light signal of claim 1, further comprising a control module connected to the heater insert for sensing moisture and one or more moisture sensors positioned on the heater insert.

8. The traffic light signal of claim 1, further comprising a control module connected to the heater insert for controlling the on/off function of the heater insert.

9. The traffic light signal of claim 1, further comprising a control module used to limit the current into the heater insert.

10. A traffic signal heater insert comprising:
a carrier having a surface, and
a heater positioned on the surface of the carrier.

11. The traffic signal heater insert of claim 10, wherein the heater is screen-printed directly on the carrier.

12. A light fixture comprising:
an LED light assembly;
a sealing gasket provided on the LED light assembly; and
a heater insert attached to the LED assembly with the sealing gasket.

13. The light fixture of claim 12, wherein at least a portion of the heater insert is in front of the LED light assembly.

14. A light fixture comprising:
LED light assembly;
a flange around the LED light assembly; and
a heater insert attached to the LED assembly to the flange.

15. The light fixture set forth in claim 14, wherein at least a portion of the heater insert is in front of the LED light assembly.

16. A traffic signal heater insert comprising:
a carrier having a surface, and
a heater positioned on the surface of the carrier and
moisture sensing circuit integrated into the heater.

17. The traffic signal heater insert of claim 16, wherein the moisture sensing circuit uses conductivity to detect moisture.

18. The traffic signal heater insert of claim 16, wherein the moisture sensing circuit uses capacitance to detect moisture.

19. The traffic signal heater insert of claim 16, wherein the moisture sensing circuit uses resistance to detect moisture.
